(19) United States
(12) Patent Application Publication
(10) Pub. No.: US 2007/0240279 A1
(43) Pub. Date: Oct. 18, 2007

(54) Detachable wheel structure of baby carriage

(76) Inventor: Yi-Cheng Tan, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/405,410

(22) Filed: Apr. 18, 2006

(51) Int. Cl. B60B 33/00

(52) U.S. Cl. 16/44

(57) ABSTRACT

The present invention relates to a detachable wheel structure of a baby carriage. In accordance with the present invention, a wheel holder can be easily separated from a coupling base by merely pressing a movable pillar such that the user can operate it in an easeful posture, thereby providing the convenience in detaching the wheel holder.

### FIELD OF THE INVENTION

The present invention relates to a wheel structure of a baby carriage, and more particularly to a wheel structure that is detachable easily from the baby carriage.

### BACKGROUND OF THE INVENTION

The baby carriage is a kind of baby appliance for enhancing the interaction between the baby and the parents by reducing the parents' load or an elder's load in carrying the baby or the infant child on the back or holding him in the arms such that they can easily go on a tour, take a walk, or go shopping together. However, the typical baby carriage is huge. As a result, the recent baby carriage can be folded to be flat, short, and small so as to occupy lesser space when it is in storage, transportation or not in use. Nevertheless, it is very hard to fold the wheel holder of the conventional baby carriage since the wheel holder has a fixed diameter dimension. This uncurable problem confines the folding result of the baby carriage. Another detachable wheel structure is described in R.O.C. application Ser. No. 93,213,510, applied by the same applicant of the present application. In this cited application, an elastic wedging device is axially mounted on a shaft of a bottom plate. A coupling part of a wheel holder is formed corresponding to the shaft and inserted in the shaft. A hooking device is mounted on the coupling part corresponding to the elastic wedging device. By pressing the elastic wedging device, the wheel holder can be separated from the shaft so as to achieve the anticipated purpose of detachment. However, the user must stoop down to the lower portion of the wheel holder for detaching the wheel holder. As a result, this kind of detachable wheel structure must be improved to permit the wheel holder to be detached easily in compliance with ergonomics.

### SUMMARY OF THE INVENTION

In view of the above-mentioned conventional drawbacks, a major object of the present invention is to disclose a detachable wheel structure of a baby carriage, wherein a coupling base is mounted on a lower portion of the baby carriage. In the present invention, a hole is formed on the coupling base to be penetrated through by a tapered movable pillar. In addition, an elastomer is located on the bottom of the movable pillar and a hoop is mounted on the coupling base. By using a first frame and a second frame of the hoop, a first region and a second region are defined. A protrudent structure having a neck-shaped portion is mounted on the top of a holder body, wherein the second frame is located to sleeve the neck-shaped portion. The movable pillar is located to penetrate through the first region. The first frame is expanded by the pressing of the movable pillar, whereby the second frame is further expanded for releasing the protrudent structure of the holder body.

### BRIEF DESCRIPTION OF THE DRAWINGS

FIG. 1 is a three-dimensional view showing the assembled extension rod, coupling base, and wheel holder of the present invention.

FIG. 2 is a three-dimensional, exploded view showing the disassembled extension rod, coupling base, and cover and a three-dimensional, exploded view showing a movable pillar, an elastomer, and a hoop of the present invention.

FIG. 3 is a three-dimensional view showing the assembled extension rod, bottom plate, and wheel holder of the present invention.

FIG. 4 is a three-dimensional, exploded view showing the disassembled extension rod, bottom plate, and wheel holder of the present invention.

### DETAILED DESCRIPTION OF THE PREFERRED EMBODIMENT

The description taken with the drawings make the structures, features, and embodiments of the present invention apparent to those skilled in the art how the present invention may be embodied in practice.

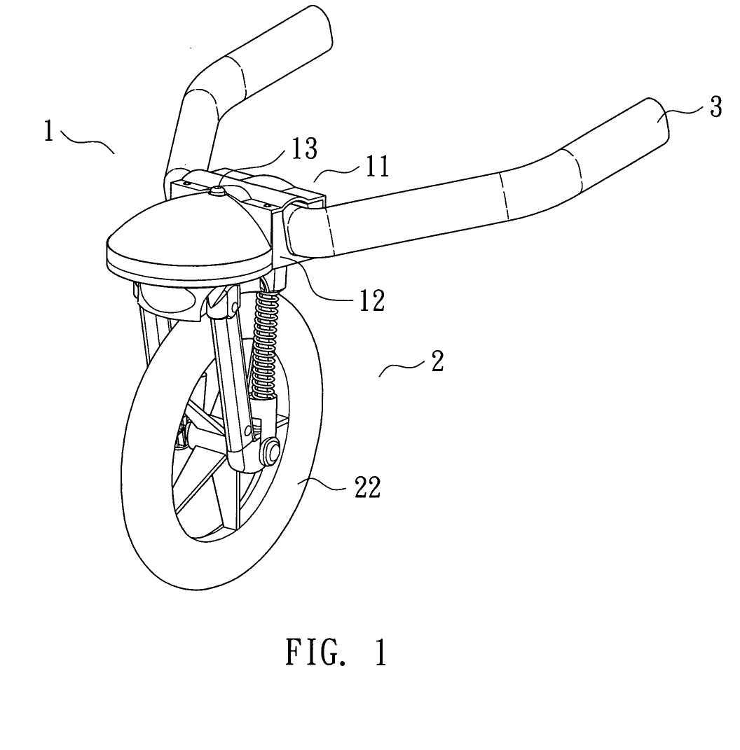

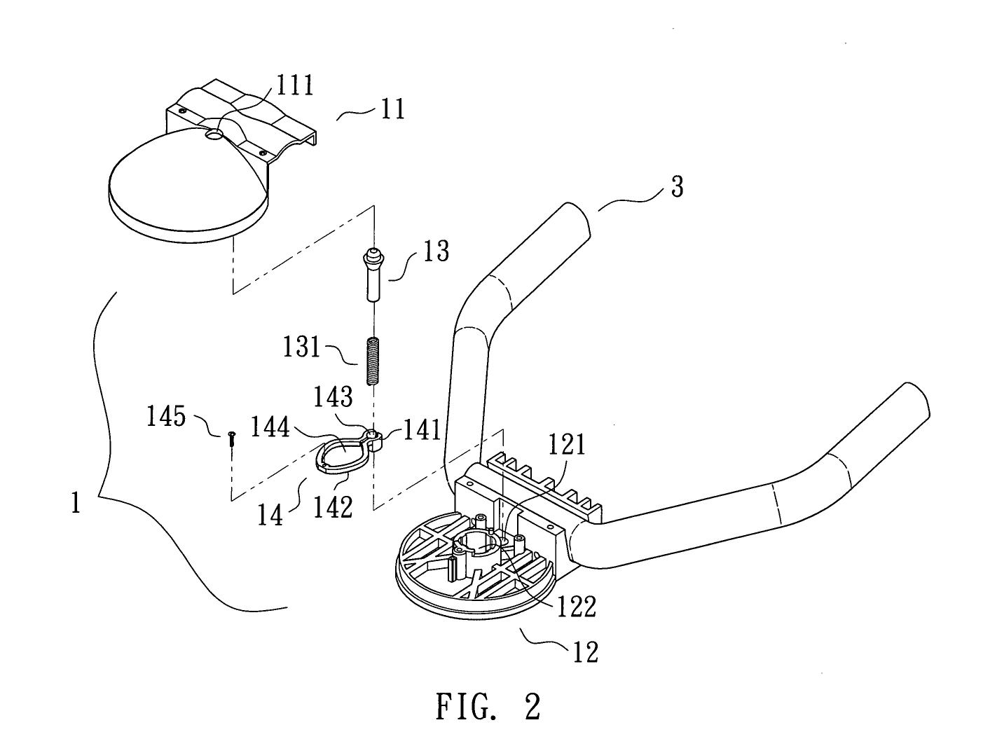

Referring to FIG. 1 and FIG. 2, a detachable wheel structure of a baby carriage of the present invention is shown.

The wheel structure comprises a coupling base 1 and a wheel holder 2. The coupling base 1, which is mounted in the front of an extension rod 3 of the baby carriage, comprises a cover 11, a bottom plate 12, a movable pillar 13, and a hoop 14. The cover 11 has a first hole 111 formed thereon. The bottom plate 12 is mounted under the cover 11 and a chamber 121 is formed on the bottom plate 12 corresponding to the first hole 111. The bottom plate 12 further has a second hole 122 formed thereon. The movable pillar 13 is hollow and located in the chamber 121 to penetrate through the first hole 111. The movable pillar 13 has an awl-shaped portion tapered from top to bottom. An optional elastomer 131 is mounted on the inside of the movable pillar 13 to lean against a wall of the chamber 121, thereby pushing the movable pillar 13 upward. The hoop 14 is screwed onto the bottom plate 12 via a screw 145. A first region 143 and a second region 144 are defined by a first frame 141 and a second frame 142 of the hoop 14, respectively.

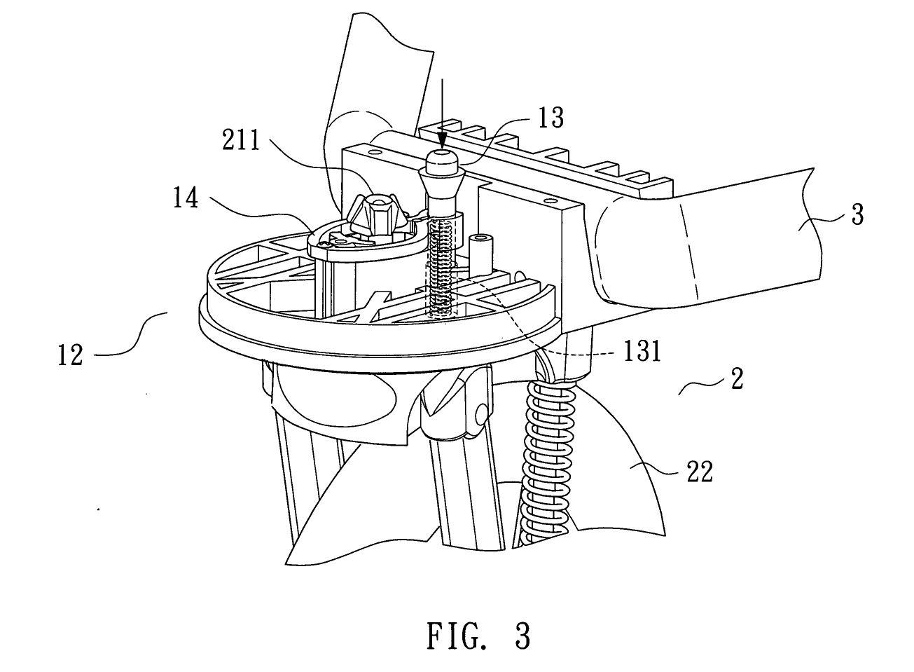

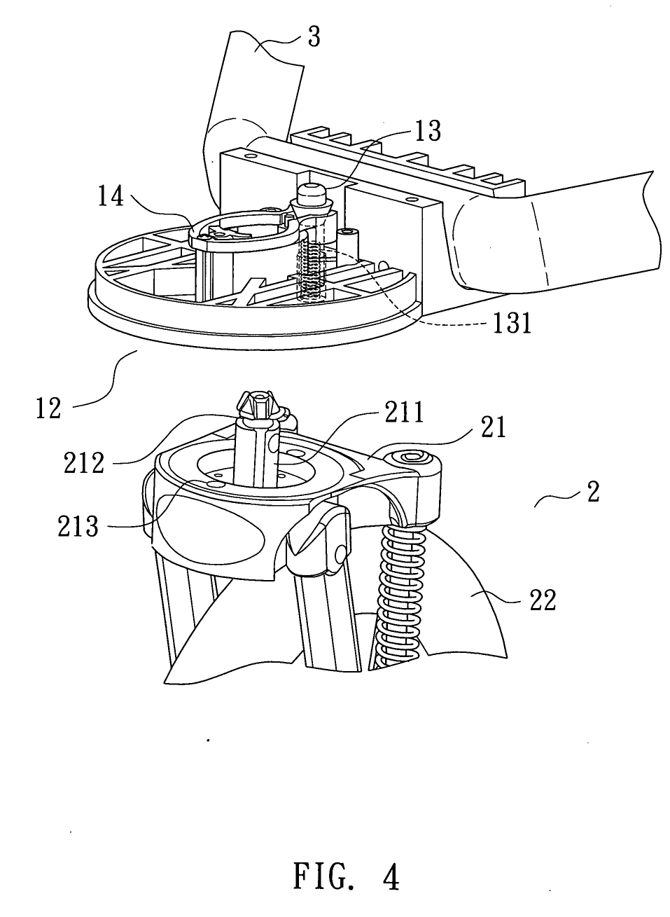

Referring to FIG. 1, FIG. 3, and FIG. 4, the wheel holder 2 comprises a holder body 21 and a wheel body 22, wherein the wheel body 22 is coupled with the holder body 21. A protrudent structure 211 is mounted on the top of the holder body 21 to penetrate through the second hole 122 of the bottom plate 12. The protrudent structure 211 has a neck-shaped portion 212 to permit the second frame 142 to sleeve the neck-shaped portion 212.

Referring to FIG. 3 and FIG. 4, the movable pillar 13 is shifted to penetrate through the first region 143 by pressing the movable pillar 13, whereby the first frame 141 is expanded outward so as to further expand the second frame 142 for releasing the protrudent structure 211 of the holder body 21. As a result, the wheel holder 2 can be easily separated from the bottom plate 12 of the coupling base 1 by merely pressing the movable pillar 13.

Moreover, the second frame 142 can be also expanded by the pressing of the movable pillar 13 even if the elastomer 131 does not exist. As a result, the wheel holder 2 can be easily detached from the bottom plate 12 of the coupling base 1 by merely pressing the movable pillar 13.

In summary, the achievable efficacy of the present invention consists in that the wheel holder 2 can be easily separated from the bottom plate 12 of the coupling base 1 by merely pressing the movable pillar 13 and that the movable pillar 13 is located vertically so the user can operate it in an easeful posture.

On the basis of the description mentioned above, the present invention indeed satisfies requirements for patentability since it provides practicability and has never been published as a printed book or used publicly. Therefore, it is submitted for a patent.

With the invention thus explained, it is apparent that various modifications and variations can be made without departing from the scope of the invention. It is therefore intended that the invention be limited only as indicated in the appended claims.

What the invention claimed is:

1. A detachable wheel structure of a baby carriage comprising:
a coupling base mounted on a lower portion of the baby carriage, the coupling base comprising:
a bottom plate having a chamber and a first hole;
a movable hollow pillar located in the chamber and having an awl-shaped portion tapered from top to bottom; and
a hoop having a first frame and a second frame for defining a first region and a second region;
a wheel holder comprising:
a holder body having a protrudent structure on the top thereof, the protrudent structure having a neck-shaped portion; and
a wheel body.

2. The detachable wheel structure of the baby carriage of claim 1, further comprising a cover mounted on the bottom plate, wherein the cover has a second hole and the movable hollow pillar is located to penetrate through the second hole.

3. The detachable wheel structure of the baby carriage of claim 1, further comprising an elastomer mounted on the inside of the movable hollow pillar to lean against a wall of the chamber for pushing the movable hollow pillar upward.
